(19) United States
(12) Patent Application Publication
(10) Pub. No.: US 2026/0205572 A1
(43) Pub. Date: Jul. 16, 2026

(54) GEOMETRIC PARTITION MODE BASED ON SUMS OF GRADIENTS

(71) Applicant: Tencent America LLC, Palo Alto, CA (US)

(72) Inventors: Lien-Fei CHEN, Palo Alto, CA (US); Biao WANG, San Jose, CA (US); Ziyue XIANG, Palo Alto, CA (US); Yifan WANG, Palo Alto, CA (US); Shan LIU, San Jose, CA (US); Roman CHERNYAK, Santa Clara, CA (US); Yonguk YOON, Palo Alto, CA (US)

(73) Assignee: Tencent America LLC, Palo Alto, CA (US)

(21) Appl. No.: 19/372,118

(22) Filed: Oct. 28, 2025

Related U.S. Application Data
(60) Provisional application No. 63/746,134, filed on Jan. 16, 2025.

(51) Int. Cl. H04N 19/103; H04N 19/176

(52) U.S. Cl. CPC H04N 19/103; H04N 19/176

(57) ABSTRACT

A method for video decoding includes for each combination of (i) a pair of vectors in one or more pairs of vectors and (ii) a GPM split mode in a list of GPM split modes, determining a temporary reconstructed block of a current block based on the respective combination and determining a sum of gradients along one of a top boundary and a left boundary of the current block based on (i) boundary samples in the temporary reconstructed block along the one of the top boundary and the left boundary and (ii) respective reconstructed neighboring samples of the current block. A GPM split mode is determined from a plurality of GPM split modes including the list of GPM split modes based at least on the sums of gradients associated with the respective combinations. The current block is reconstructed according to the GPM and the GPM split mode.

### RELATED APPLICATION

The present application claims the benefit of priority to U.S. Provisional Application No. 63/746,134, “GEOMETRIC PARTITION MODE IMPROVEMENT” filed on Jan. 16, 2025, which is incorporated by reference in its entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression may help transmit image/video data across different devices, storage and networks with minimal quality degradation. In some examples, video codec technology may compress video based on spatial and temporal redundancy. In an example, a video codec may use techniques referred to as intra prediction that may compress an image based on spatial redundancy. For example, the intra prediction may use reference data from the current picture under reconstruction for sample prediction. In another example, a video codec may use techniques referred to as inter prediction that may compress an image based on temporal redundancy. For example, the inter prediction may predict samples in a current picture from a previously reconstructed picture with motion compensation. The motion compensation may be indicated by a motion vector (MV).

### SUMMARY

Aspects of the disclosure provide a method for video decoding. In the method of video decoding, coded information indicating that a current block is coded with a geometric partition mode (GPM) is received. One or more pairs of vectors are available to predict the current block. For each combination of (i) a pair of vectors in the one or more pairs of vectors and (ii) a GPM split mode in a list of GPM split modes, a temporary reconstructed block of the current block is determined based on the respective combination of the pair of vectors and the GPM split mode, and a sum of gradients along at least one of a top coding block boundary and a left coding block boundary of the current block is determined based at least on (i) boundary samples in the temporary reconstructed block that are along the at least one of the top coding block boundary and the left coding block boundary and (ii) respective reconstructed neighboring samples of the current block. A GPM split mode is determined from a plurality of GPM split modes including the list of GPM split modes based at least on the sums of gradients associated with the respective combinations. The current block is reconstructed according to the GPM and the determined GPM split mode.

Aspects of the disclosure also provide an apparatus for video decoding. The apparatus for video decoding includes processing circuitry configured to implement any of the described methods for video decoding.

Aspects of the disclosure also provide a method for video encoding. In the method for video encoding, for each combination of (i) a pair of vectors in one or more pairs of vectors and (ii) a geometric partition mode (GPM) split mode in a list of GPM split modes, a temporary reconstructed block of a current block is determined based on the respective combination of the pair of vectors and the GPM split mode. The current block is coded with the GPM. A sum of gradients along at least one of a top coding block boundary and a left coding block boundary of the current block is determined based at least on (i) boundary samples in the temporary reconstructed block that are along the at least one of the top coding block boundary and the left coding block boundary and (ii) respective reconstructed neighboring samples of the current block. A GPM split mode is determined from a plurality of GPM split modes including the list of GPM split modes based at least on the sums of gradients associated with the respective combinations. The current block is then encoded according to the GPM and the determined GPM split mode.

Aspects of the disclosure also provide an apparatus for video encoding. The apparatus for video encoding includes processing circuitry configured to implement any of the described methods for video encoding.

Aspects of the disclosure also provide a non-transitory computer-readable medium storing instructions which, when executed by a computer, cause the computer to perform any of the described methods for video decoding/encoding.

In an aspect, a non-transitory computer-readable storage medium storing instructions which when executed by a processor cause the processor to perform an encoding method. In the encoding method, for each combination of a pair of vectors in one or more pairs of vectors and a geometric partition mode (GPM) split mode in a list of GPM split modes, a temporary reconstructed block of a current block is determined based on the respective combination of the pair of vectors and the GPM split mode, with the current block being coded with the GPM. A sum of gradients along at least one of a top coding block boundary and a left coding block boundary of the current block is then determined based at least on boundary samples in the temporary reconstructed block that are along the at least one of the top coding block boundary and the left coding block boundary and on respective reconstructed neighboring samples of the current block. A GPM split mode from a plurality of GPM split modes including the list of GPM split modes is determined based at least on the sums of gradients associated with the respective combinations. The current block is encoded according to the GPM and the determined GPM split mode. A bitstream including the encoded current block and coded information indicating that the current block is coded with the GPM is transmitted.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4A shows an example of a geometric partition mode (GPM) applied to a block according to an aspect of the disclosure.

FIG. 4B shows a predefined number of angles distributed from 0° to 360° for a GPM according to an aspect of the disclosure.

FIG. 4C shows multiple partition edges corresponding to an angle for a GPM according to an aspect of the disclosure.

FIG. 4D shows an example of a GPM blending process applied to a current block according to an aspect of the disclosure.

FIG. 5 shows examples of GPM splits grouped by identical angles according to an aspect of the disclosure.

FIG. 6 shows an example of a GPM split mode according to an aspect of the disclosure.

FIG. 7 shows an example of determining a sum of gradients according to an aspect of the disclosure.

FIG. 8 shows an example where gradients are determined based on a plurality of lines of reconstructed neighboring samples according to an aspect of the disclosure.

FIG. 9 shows angles distributed from 0° to 360° for a GPM according to an aspect of the disclosure.

FIG. 10 shows a flow chart outlining a decoding process according to some aspects of the disclosure.

FIG. 11 shows a flow chart outlining a process (1100) according to an aspect of the disclosure.

FIG. 12 is a schematic illustration of a computer system in accordance with an aspect.

### DETAILED DESCRIPTION

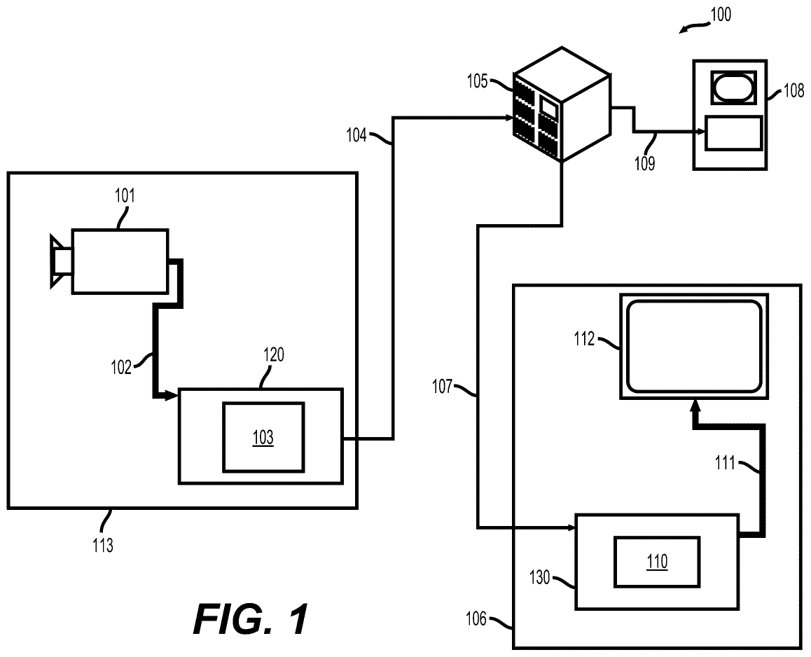

FIG. 1 shows a block diagram of a video processing system (100) in some examples. The video processing system (100) is an example of an application for the disclosed subject matter, a video encoder and a video decoder in a streaming environment. The disclosed subject matter may be equally applicable to other video enabled applications, including, for example, video conferencing, digital TV, streaming services, storing of compressed video on digital media including CD, DVD, memory stick and the like, and so on.

The video processing system (100) includes a capture subsystem (113), that may include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), may be processed by an electronic device (120) that includes a video encoder (103) coupled to the video source (101). The video encoder (103) may include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), may be stored on a streaming server (105) for future use. One or more streaming client subsystems, such as client subsystems (106) and (108) in FIG. 1 may access the streaming server (105) to retrieve copies (107) and (109) of the encoded video data (104). A client subsystem (106) may include a video decoder (110), for example, in an electronic device (130). The video decoder (110) decodes the incoming copy (107) of the encoded video data and creates an outgoing stream of video pictures (111) that may be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

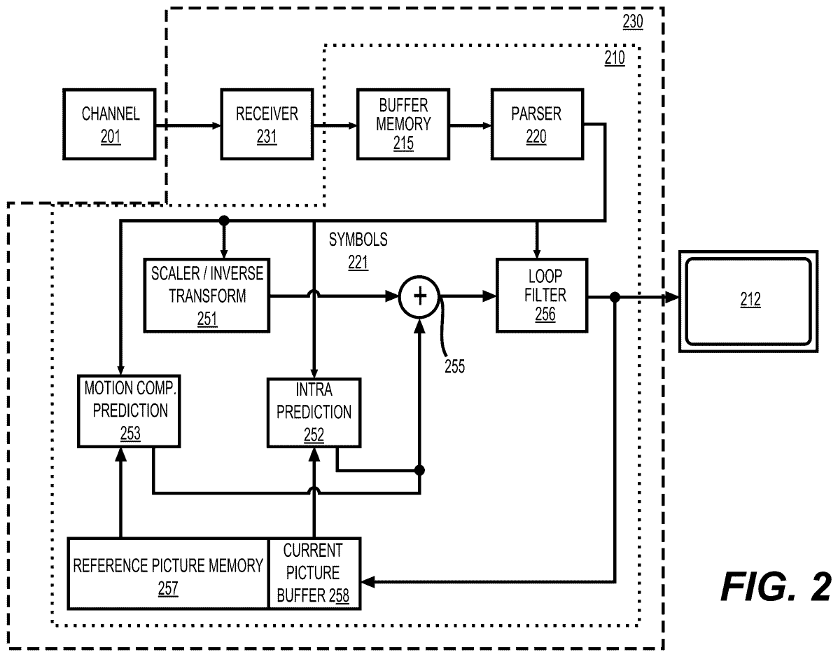

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

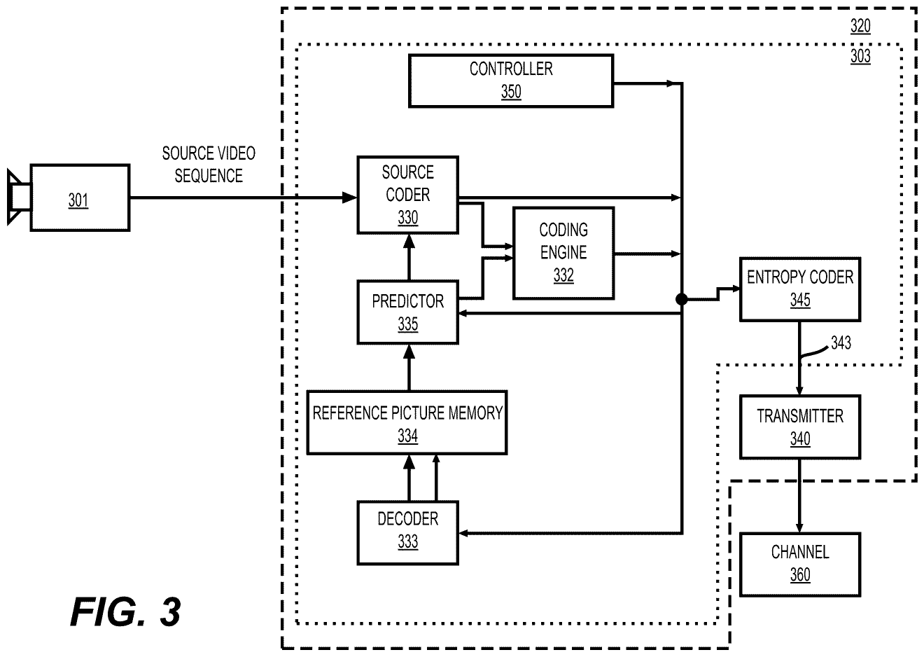

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can include one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may include temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes use of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Video coding has been widely used in many applications such as broadcasting, video recording, video streaming, and the like. Various emerging video coding standards such as H.264, H.265/HEVC, H.266/VVC, and AV1 are adopted in the video applications. A hybrid video codec can include coding modules, intra prediction, inter prediction, transform coding, quantization, entropy coding, post in-loop filters, and the like.

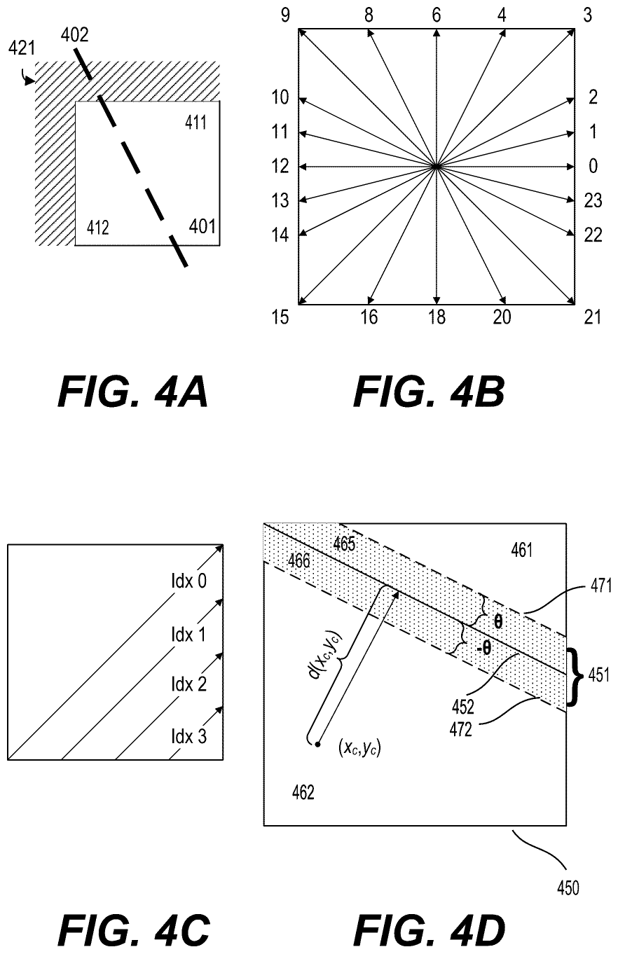

In an aspect, geometric partition prediction is a prediction mode with two different geometric partitions by using a geometric split edge (also referred to as a GPM partition edge). The geometric partition prediction can be referred to as geometric partition mode (GPM). FIG. 4A shows an example of the GPM applied to a block (401) according to an aspect of the disclosure. The block (401) can be partitioned into partitions (411)-(412) by a geometric split edge (402). Each partition can be coded in a suitable prediction mode, such as an intra prediction mode, an inter prediction mode, a block vector (BV) based prediction mode, or the like. A BV-based prediction mode may include an intra block copy (IBC) mode, an intra template matching prediction (IntraTMP) mode, or the like. In the BV-based prediction mode, a current block in a current picture is to be predicted. A reference block that is in an already reconstructed region in the current picture can be determined, and a BV can indicate (e.g., point to) the reference block from the current block. In an example, the geometric split edge (402) extends into a template (421) of the block (401). In an example, a combination of a partition mode and a combination of prediction modes (e.g., inter prediction mode(s) and/or BV-based prediction mode(s)) for the two partitions (411)-(412) can be signaled in a bitstream. In an example, three syntax elements can be signaled to indicate which partition mode and which prediction modes (e.g., inter prediction mode(s) and/or BV-based prediction mode(s)) are applied to the two partitions (411)-(412).

The GPM can be used for inter prediction, such as in VVC. In an example, the GPM is only applied to CUs that are 8×8 or larger. In an aspect, when the GPM is used, a CU can be split into two geometric-shaped partitions (also referred to as a geometric partition or a partition) by using one of a predefined number (e.g., 64) of different partitioning manners or GPM split modes. A geometric partition index (or a GPM split mode index) can be used to indicate a partitioning manner or a GPM split mode, such as one out of the 64 different partitioning manners. The different partitioning manners can be differentiated by a predefined number (e.g., 24) of angles (e.g., non-uniformly quantized between 0 and 360°) and up to a predefined number (e.g., 4) of partition edges (also referred to as geometric split edges or GPM split edges) relative to a center of the CU, such as shown in FIGS. 4B-4C.

FIG. 4B shows a predefined number of angles (or multiple angles) distributed from 0° to 360°, such as 24 supported angles in VVC, according to an aspect of the disclosure. The multiple angles can be indicated by respective angle indices 0-23. FIG. 4C shows multiple partition edges (e.g., 4 partition edges indicated by respective indices (idx) 0-3) corresponding to one of the multiple angles, such as supported possible partition edges for the angle index 3, according to an aspect of the disclosure. A set of GPM split modes that is available to code a block can be based on a suitable combination of the multiple angles and the associated partition edge(s) shown in FIGS. 4B-4C.

In an aspect, each geometric partition in the CU is inter-predicted using respective motion information. In an example, only uni-prediction is allowed for each partition, for example, each partition has a respective MV and a respective reference index. The uni-prediction motion constraint can be applied to ensure that only two motion compensated predictions are used for each CU which is the same when a bi-prediction is applied to the entire CU. In some examples, bi-prediction is applied to a partition in the CU.

In an aspect, inter prediction and another prediction (e.g., a BV-based prediction) are used for the geometric partitions in the CU.

If the GPM is used for a CU, information indicating a geometric partition index for the CU and prediction information of two geometric partitions in the CU can be signaled. In an example, the prediction information includes two merge indices if each geometric partition in the CU is inter-predicted. The prediction information can include a merge index and an index indicating an intra prediction mode if inter prediction and intra prediction are used for the geometric partitions in the CU.

After predicting the two geometric partitions, sample values in a blending region (including samples along the partition edge) can be adjusted using a blending process (or a GPM blending process) with adaptive weights. A size of the blending region can be indicated by a blending width θ shown in FIG. 4C. The blending width θ can be a width of the blending area measured perpendicular to the partition edge (452).

In an aspect, the blending width θ is fixed, for example, for CUs having different contents, such as natural contents, screen contents, a mixture of natural content(s) and screen content(s), and the like. In an aspect, the blending width θ is adaptive, for example, is selected from a blending width set (also referred to as a width candidate list).

FIG. 4D shows an example of a GPM blending process applied to a CU (450) according to an aspect of the disclosure. The CU (450) can be partitioned into geometric partitions (461)-(462) by a partition edge (452). In an example, a first prediction mode and a second prediction mode are applied to predict samples in the CU (450) as P0 and P1, respectively. The first prediction mode and the second prediction mode can include suitable prediction mode(s), such as inter prediction mode(s), an IBC mode, an IntraTMP mode, and/or the like.

The partition edge (452) can be oriented at an angle that corresponds to an angle index (e.g., the angle index 10 or 22 in FIG. 4B). The partition edge (452) and the angle index can correspond to a geometric partition index of the CU (450).

A blending region or a blending area (451) can include samples along the partition edge (452). The blending region (451) can include samples that are within a distance (or the blending width) θ from the partition edge (452). Boundaries (471)-(472) of the blending region (451) are parallel to the partition edge (452) and are separated from the partition edge (452) by the distance θ. In an example, the blending region (451) includes a first blending region (465) and a second blending region (466) that are separated by the partition edge (452). The first blending region (465) can be within the partitions (461) and the second blending region (466) can be within the partition (462).

A sample in the CU (450) can be determined based on the blending process, for example, as a weighted sum P.

$$P = ( 1 - W ) \times P 1 + W \times P 0 \qquad Eq . 1$$

P0 and P1 can represent prediction values of the sample based on the first prediction mode and the second prediction mode, respectively. A weight (W) can be determined for the sample in the CU (450) based on a displacement d (x_{c},y_{c}) of the sample in the CU (450) from the partition edge (452).

A blending mask can be applied to the CU (450), and weights (or weighing values) ω_{xc,yc} in the blending mask can be given by a ramp function below. In an example, W is ω_{xc,yc}/8.

$${ω}_{{x}_{c} , {y}_{c}} = \{ \begin{matrix}0 & d ( {x}_{c} , {y}_{c} ) \leq = θ \\ \frac{8}{2 θ} ( d ( {x}_{c} , {y}_{c} ) + θ ) & - θ < d ( {x}_{c} , {y}_{c} ) < θ \\ 8 & d ( {x}_{c} , {y}_{c} ) \geq θ\end{matrix} , \qquad Eq . 2$$

When the sample (x_{c},y_{c}) is located in the partition (462) and outside the second blending region (466), the displacement d (x_{c},y_{c}) is less than or equal to −θ, and ω_{xc,yc} and W is 0. Accordingly, the samples in the partition (462) that are outside the blending region (451) can be predicted as P1 based on the second prediction mode.

When the sample (x_{c},y_{c}) is located in the partition (461) and outside the first blending region (465), the displacement d(x_{c},y_{c}) is larger than or equal to θ, and ω_{xc,yc} is 8 and W is 1. Accordingly, the samples in the partition (461) that are outside the blending region (451) can be predicted as P0 based on the first prediction mode. In an example, no blending is used for the samples that are outside the blending region (451).

When the sample (x_{c},y_{c}) is located in the blending region (451), the displacement d(x_{c},y_{c}) is between −θ and θ, and ω_{xc,yc} is determined based on the displacement d(x_{c},y_{c}), such as shown in Eq. 2. The samples in the blending region (451) can be predicted as the weighted sum of P0 and P1 as described in Eq. 1.

In an example, θ is fixed as 2 pixels (pel), such as in the current VVC design, the ramp function ω_{xc,yc} can be quantized as ω_{m,n}

$${ω}_{m , n} = Clip 3 ( 0 , 8 , ( d ( m , n ) + 32 + 4 ) >> 3 ) \qquad Eq . 3$$

In an example, d (m, n) is 16×d(x_{c},y_{c}).

The blended results P (e.g., the predicted sample values the CU (450)) can include the prediction signal for the CU (450) (e.g., the entire CU (450)). A transform process and a quantization process can be applied to the CU (450) as in other prediction modes. The motion field of the CU (450) predicted using the GPM can be stored.

A partition mode in the GPM can indicate a geometric split edge and a geometric partition by using the geometric split edge.

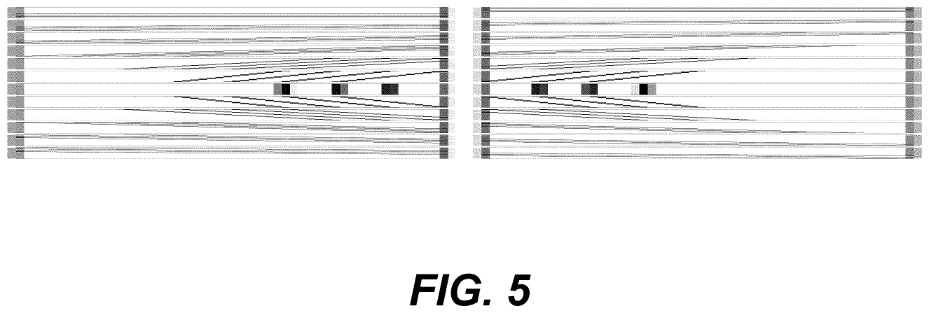

In some examples, such as in VVC, the GPM is supported for inter prediction. In an example, a total of 64 partitions are supported by the GPM for each possible CU size of w×h=2^{m}×2ⁿ with m, n∈{3 . . . 6} excluding 8×64 and 64×8. When the GPM mode is used, a CU is split into two parts by a geometrically located straight line (e.g., (402) in FIG. 4A). The location of the splitting line may be mathematically derived from an angle and offset parameters of a specific partition. In some examples, each part of a geometric partition in the CU is inter-predicted using its own motion (e.g., an MV), IBC-predicted using a BV, IntraTMP-predicted using a BV, or the like. FIG. 5 shows examples of the GPM splits grouped by identical angles according to an aspect of the disclosure.

Improvement methods on the GPM, such as improvements to GPM signaling, are described.

In some aspects, in order to improve the signaling of a GPM split mode, template-matching (TM)-based reordering method is used. In the TM-based reordering for GPM split modes, given the motion information (e.g., a pair of MVs) and/or BV information of the current GPM block, respective TM cost values of GPM split modes are computed. Then, GPM split modes (e.g., all GPM split modes) such as 64 GPM split modes are reordered, for example, in an ascending order, based on the TM cost values. Instead of signaling the GPM split mode, an index (e.g., using a Golomb-Rice code) to indicate the GPM split mode in the reordered list (e.g., where the GPM split mode is located in the reordered list) is signaled. The TM-based reordering method for the GPM split modes may include a two-step process performed after the respective reference templates of the two GPM partitions in a coding unit are generated. In an example, the two-step process includes:
Step 1: extending the GPM partition edge into reference templates of the two GPM partitions, resulting in 64 reference templates and computing the respective TM cost for each of the 64 reference templates; and
Step 2: reordering the GPM split modes based on the TM cost values, for example, in the ascending order and marking the best N1 (e.g., 32) GPM split modes as available GPM split modes. In an example, the TM cost values of the best N1 GPM split modes are less than the TM cost values of remaining GPM split modes.

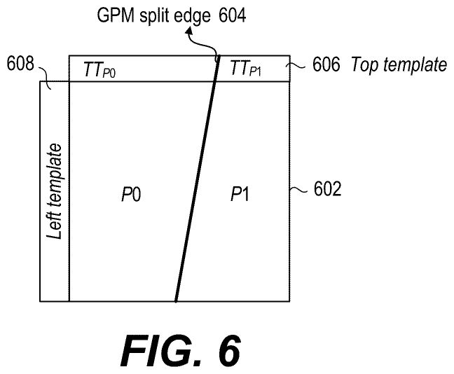

FIG. 6 shows an example of a GPM split mode according to an aspect of the disclosure. An edge (also referred to as a GPM split edge) (604) on a current template of a current CU (602) is extended from the edge (604) that divides the current CU (602). The current CU (602) is partitioned into a first partition P0 and a second partition P1 according to the GPM split edge (604).

The current template of the current CU (602) may include a top template (606) along a top side of the current CU (602) and/or a left template (608) along a left side of the current CU (602). In an example, as shown in FIG. 6, the top template (606) is split into two partitions TT_{P0} and TT_{P1}. The TT_{P0} and the left template (608) may be used as a first template region, and a corresponding first reference template region is generated based on the first template region. The TT_{P1} may be used as a second template region, and a corresponding second reference template region is generated based on TT_{P1}. A reference template includes the first reference template region and the second reference template region. The TM cost associated with the GPM split mode (or the GPM split edge (604)) is computed based on the current template and the reference template.

In some examples, in order to reduce a signaling overhead, a GPM candidate list is built with each entry including a GPM split mode and the prediction information (e.g., motion information and/or BV information) of the two GPM partitions. The GPM candidate list is reordered using the template-based scheme (e.g., the TM-based reordering) and a selected entry indicating the GPM split mode and the prediction information (e.g., the motion information and/or the BV information) is signaled to a decoder.

According to an aspect of the disclosure, a sum of gradients based method is used, for example, to improve the signaling of the GPM split mode. For example, the sum of the gradients is calculated along a boundary of a current block, such as along a top and left coding block boundary of the current block. The signaling of the GPM split mode may be determined by calculating a sum of gradients for each GPM split mode, such as the sums of gradients for all GPM split modes.

In an aspect, coded information is received indicating that a current block is coded using the GPM. One or more pairs of vectors are available to predict the current block. In an example, for each combination of (i) a pair of vectors from the one or more pairs of vectors and (ii) a GPM split mode from a list of GPM split modes, a temporary reconstructed block (also referred to as a GPM block) of the current block is determined based on the respective combination of the pair of vectors and the GPM split mode, and a sum of gradients along at least one of a top coding block boundary and a left coding block boundary of the current block is determined based at least on (i) boundary samples in the temporary reconstructed block that are along the at least one of the top coding block boundary and the left coding block boundary and (ii) respective reconstructed neighboring samples of the current block. In an aspect, a GPM split mode is determined from a plurality of GPM split modes based at least on the sums of gradients associated with the respective combinations. The plurality of GPM split modes includes the list of GPM split modes. In an aspect, the current block is reconstructed according to the GPM and the determined GPM split mode.

In an example, the at least one of the top coding block boundary and the left coding block boundary of the current block includes the top coding block boundary and the left coding block boundary of the current block.

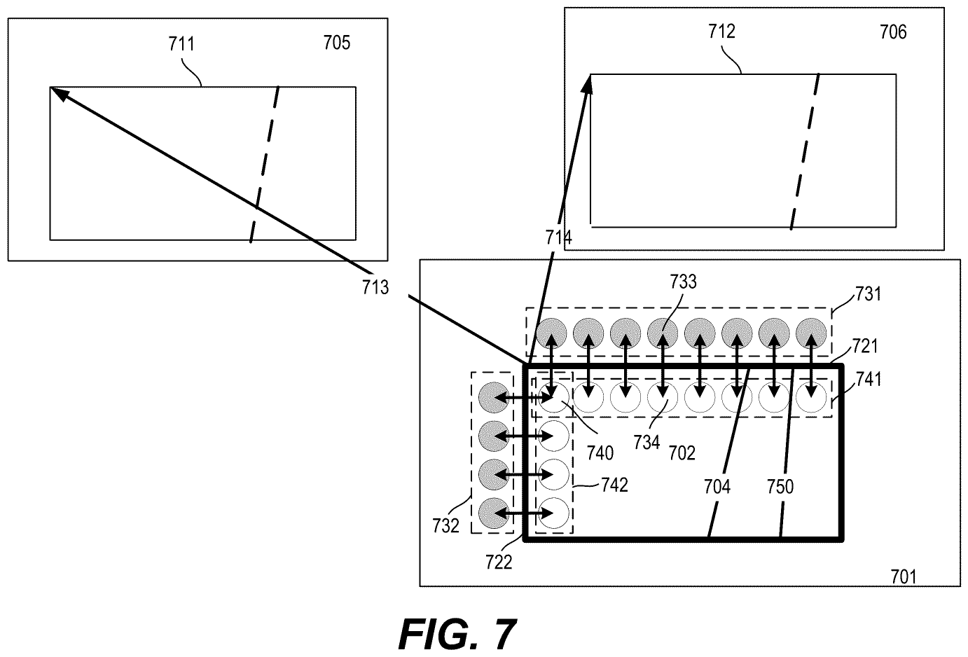

FIG. 7 shows an example of determining a sum of gradients according to an aspect of the disclosure. A current block (702) in a current picture (701) is predicted using the GPM. One or more pairs of vectors and a list of GPM split modes are available to predict the current block. In an example, each pair of vectors in the one or more pairs of vectors includes (i) two motion vectors (MVs) for inter prediction, (ii) two BVs for the IBC mode and/or the IntraTMP mode, or (iii) an MV for the inter prediction and a BV for the IBC mode or the IntraTMP mode. In an example, the one or more pairs of vectors is a pair of vectors (713)-(714) shown in FIG. 7. In an example, the one or more pairs of vectors include a plurality of pairs of vectors.

In an example, the list of GPM split modes includes a GPM split mode having a GPM split edge (or a GPM partition edge) (704). For a combination of (i) the pair of vectors (713)-(714) from the one or more pairs of vectors and (ii) the GPM split mode having the GPM split edge (704), a temporary reconstructed block of the current block (702) is determined as follows.

In an example, the pair of vectors (713)-(714) includes two MVs, such as an MV (713) and an MV (714). In an example, sample values of the temporary reconstructed block of the current block (702) is determined based at least on P which is a weighted sum of P0 and P1 as described in Eqs. 1-3. P0 and P1 can represent prediction values of the samples in the current block (702) based on the first prediction mode (e.g., an inter prediction indicated by the MV (713)) and the second prediction mode (e.g., an inter prediction indicated by the MV (714)), respectively. Referring to FIG. 7, the MV (713) indicates a reference block (711) in a reference picture (705), and P0 includes values of reference samples (e.g., already reconstructed) in the reference block (711). The MV (714) indicates a reference block (712) in a reference picture (706), and P1 includes values of reference samples (e.g., already reconstructed) in the reference block (712). In an example, a weight (W) can be determined for the samples in the current block (702) based on respective displacements of the samples in the current block (702) from the edge (704).

In an aspect, the temporary reconstructed block (or the GPM block) is the prediction block (e.g., P as shown in Eq. 1) which is generated and blended from two prediction blocks (e.g., P0 and P1) by using the GPM blending mask. In this case, two prediction blocks are predicted by using the inter prediction (e.g., a vector in the pair of vectors is an MV), the IBC mode (e.g., a vector in the pair of vectors is a BV), the IntraTMP mode (e.g., a vector in the pair of vectors is a BV), and/or the like. In an example, the two prediction blocks are predicted by using the inter prediction, the IBC mode, and/or the IntraTMP mode. In an example, when the pair of vectors (713)-(714) is a pair of MVs, the two prediction blocks are motion compensated blocks with the corresponding motions.

As described in FIG. 7, for each combination of (i) the pair of vectors (e.g., (713)-(714)) in the one or more pairs of vectors and (ii) the GPM split mode (e.g., having the edge (704)) in the list of GPM split modes, a first prediction (e.g., P0) of the current block (702) is determined based on a first vector (e.g., (713)) of the respective pair of vectors, a second prediction (e.g., P1) of the current block (702) is determined based on a second vector (e.g., (714)) of the respective pair of vectors, and the temporary reconstructed block (e.g., P) of the current block (702) is determined by blending the first prediction (e.g., P0) and the second prediction (e.g., P1) based on the respective GPM split mode (e.g., having the edge (704)) and a blending width.

In an aspect, the temporary reconstructed block (or the GPM block) may be constructed based on the prediction block (e.g., P as shown in Eq. 1) described above and a residual coding block (also referred to as a residual block). The residual coding block may be the same for all the GPM split modes. In an example, the residual coding block is signaled in the bitstream.

In an example, for each combination of (i) the pair of vectors (e.g., (713)-(714)) in the one or more pairs of vectors and (ii) the GPM split mode (e.g., having the edge (704)) in the list of GPM split modes, the first prediction (e.g., P0) of the current block (702) is determined based on the first vector (e.g., (713)) of the respective pair of vectors, the second prediction (e.g., P1) of the current block (702) is determined based on the second vector (e.g., (714)) of the respective pair of vectors, an intermediate block (e.g., P) of the current block (702) is determined by blending the first prediction (e.g., P0) and the second prediction (e.g., P1) based on the respective GPM split mode (e.g., having the edge (704)) and the blending width. The temporary reconstructed block of the current block (702) is determined based on the intermediate block (e.g., P) and a residual block. In an example, the temporary reconstructed block of the current block (702) is determined as a sum of the intermediate block (e.g., P) and the residual block.

In an aspect, the sum of gradients along a boundary of the current block (702) is determined. The boundary of the current block (702) may include (i) at least one portion of a top coding block boundary (also referred to as a top boundary) (721), (ii) at least one portion of a left coding block boundary (722), and/or the like. In an example shown in FIG. 7, the boundary of the current block (702) includes (i) the top coding block boundary (721) and (ii) the left coding block boundary (722).

The sum of gradients along the boundary of the current block (702) is determined based on (i) boundary samples (741)-(742) in the temporary reconstructed block that are along the top coding block boundary (721) and the left coding block boundary (722) and (ii) respective reconstructed neighboring samples (731)-(732) of the current block (702). Referring to FIG. 7, the neighboring samples (731)-(732) of the current block (702) are already reconstructed. The samples (741)-(742) are in the current block (702) and are along the boundary of the current block (702). The samples (741)-(742) include a row of samples (741) and a column of samples (742). Both the row of samples (741) and the column of samples (742) include the sample (740).

In an example, a gradient is between one (e.g., (733)) of the reconstructed neighboring samples (731)-(732) and a corresponding one (e.g., (734)) of the boundary samples (741)-(742), such as the gradient between the samples (733)-(734). In an example, the gradient is indicated by an absolute difference between the reconstructed sample value of the sample (733) and the value of the sample (734) in the temporary reconstructed block. The sum of gradients may be obtained by adding the gradients.

FIG. 7 shows an example where the gradients are determined based on one line (e.g., a column and/or a row) of reconstructed neighboring samples such as (731)-(732).

In some examples, one or more lines (e.g., 2 lines such as two columns and/or two rows) of reconstructed neighboring samples, one or more lines (e.g., 2 lines) of boundary samples in the temporary reconstructed block, and/or the like are used to determine the gradients. FIG. 8 shows an example where the gradients are determined based on a plurality of lines (e.g., 2 lines) of reconstructed neighboring samples such as (831)-(832) according to an aspect of the disclosure. Referring to FIG. 8, the reconstructed neighboring samples (831) include two rows of reconstructed neighboring samples above the current block (702), and the reconstructed neighboring samples (832) include two columns of reconstructed neighboring samples to the left of the current block (702). In an example, the gradient (denoted as g) is determined as a sum of absolute second derivatives for the above row and left column based on Eq. 4.

$$g = {\sum }_{x = o}^{w} \vert ( - {R}_{x , - 1} + 2 {R}_{x , 0} - {P}_{x , 1} ) \vert + {\sum }_{y = o}^{h} \vert ( - {R}_{- 1 , y} + 2 {R}_{0 , y} - {P}_{1 , y} ) \vert \qquad Eq . 4$$

R is a value of a reconstructed neighboring sample in (831)-(832). P is a value of the boundary sample (e.g., one of (741)-(742)) of the temporary reconstructed block.

Referring to FIG. 7, the values of the reconstructed neighboring samples (e.g., (731)-(732)) of the current block (702) do not vary with the GPM split mode or the pair of vectors (713)-(714). The values of the boundary samples (741)-(742) vary with the GPM split mode or the pair of vectors (713)-(714). For example, the reference blocks (711)-(712) change with the pair of vectors (713)-(714). Thus, P0, P1, and the values of the temporary reconstructed block vary with the pair of vectors (713)-(714). In an example, the pair of vectors (713)-(714) remains the same as shown in FIG. 7, and the GPM split mode has a GPM split edge (750) that is different from the GPM split edge (704). In this case, P0 and P1 are the same as shown in FIG. 7, however, the weights of P0 and P1 corresponding to the GPM split edge (750) are different from those corresponding to the GPM split edge (704).

Accordingly, the sum of gradients between the boundary samples (741)-(742) and the reconstructed neighboring samples (731)-(732) varies with each combination of (i) the pair of vectors in the one or more pairs of vectors and (ii) the GPM split mode in the list of GPM split modes.

In an aspect, the sum of gradients for the list of GPM split modes are calculated and the list of GPM split modes is reordered, for example, in an ascending order. A syntax such as a syntax element is signaled to indicate which candidate (e.g., which GPM split mode) within the reordered list of GPM split modes is selected. In an example, the list of GPM split modes is reordered based on the sums of the gradients, and the GPM split mode is determined based on the syntax element in the coded information. The syntax element indicates the GPM split mode in the reordered list of GPM split modes, and the plurality of GPM split modes is the list of GPM split modes.

In an aspect, the coded information includes a first flag indicating that the list of GPM split modes is reordered based on the sums of gradients. For example, the first flag is signaled to indicate whether the sum of gradients based signaling method is used or not. If the first flag is true, the list of GPM split modes is reordered based on the sums of gradients. Otherwise, the TM-based reordering method or another signaling method (e.g., the signaling method used in VVC) is applied. In an example, the first flag is signaled at a slice level, a SPS level, a PPS level, or the like. In an example, the first flag is signaled at a level that is higher than a block level.

In an aspect, a second flag is signaled to indicate whether the sum of gradients based signaling method is used or not. If the second flag is true, the GPM split mode with the smallest sum of gradient is used. In this case, there is no need to signal an index for the GPM split mode. Otherwise, if the second flag is not true, the TM-based reordering method or another signaling method (e.g., the signaling method used in VVC) is applied. In an example, the second flag is signaled at a block level. For example, the coded information includes the second flag indicating a GPM split mode in the list of GPM split modes corresponding to the smallest sum of gradients in the sums of gradients is to be the GPM split mode. The plurality of GPM split modes is the list of GPM split modes. That the GPM split mode corresponding to the smallest sum of gradients in the sums of gradients is the GPM split mode is determined.

In an aspect, the first flag and/or the second flag may be signaled at any suitable level, such as the SPS level, the PPS level, the slice level, the block level, or the like.

In some examples, heterogeneous ranking criteria are combined, for example by interleaving lists independently reordered under different metrics, such as TM costs in the TM-based reordering method and sums of gradients in the sum of gradients based reordering method.

In an aspect, the TM-based reordering method and the sum of gradients based reordering method are applied to derive two reordering lists (e.g., the TM-based reordering list and the sum of gradients reordering list), respectively. A final reordering list is constructed by using the candidates from the two reordering lists, for example, the two reordering lists are interleaved. In an example, the even candidates in the final reordering list are derived from the TM-based reordering list and the odd candidates are derived from the sum of gradients reordering list. Duplicate candidates are skipped, and the next non-duplicate is used to construct the final list. For example, a duplicated candidate that is from either the TM-based reordering list or the sum of gradients reordering list and is identical to one of the current existing candidates in the final list is bypassed and the following non-duplicated candidate is used for candidate derivation. For example, the TM-based reordering list is [0, 1, 2, 3, 4, 5, 6, 7] and includes the GPM split modes 0 to 7, and the sum of gradients reordering list is [1, 0, 2, 3, 4, 7, 6, 5] and includes the GPM split modes 0 to 7. Each list is organized from the Oth entry to the 7th entry. In this example, the even candidates in the TM-based reordering list include the GPM split modes 0, 2, 4, and 6, and the odd candidates in the sum of gradients reordering list include the GPM split modes 0, 3, 7, and 5. Thus, when the even candidates in the final reordering list are derived from the TM-based reordering list and the odd candidates are derived from the sum of gradients reordering list and the duplicated candidates are excluded as described above, the final reordering list is [0, 1, 2, 3, 4, 7, 6, 5] if the 0^{th} (even) candidate is from the TM-based reordering list.

In an example, the odd candidates in the final reordering list are derived from the TM-based reordering list and the even candidates are derived from the sum of gradients reordering list. Thus, when the duplicated candidates are excluded as described above, the final reordering list is [1, 0, 2, 3, 4, 5, 6, 7] if the 0^{th} (even) candidate is from the sum of gradients reordering list.

For example, the list of GPM split modes is reordered based on the sums of gradients as a first reordered list of GPM split modes such as [1, 0, 2, 3, 4, 7, 6, 5]. The list of GPM split modes is reordered based on the TM-based reordering as follows. For each combination of (i) the pair of vectors in the one or more pairs of vectors and (ii) the GPM split mode in the list of GPM split modes, a reference block of the current block is determined based on the respective pair of vectors and the respective GPM split mode, and a TM cost between a reference template of the reference block and a current template of the current block is determined. The list of GPM split modes is reordered based on the TM costs as a second reordered list of GPM split modes such as [0, 1, 2, 3, 4, 5, 6, 7]. The GPM split mode may be determined as follows: a final reordered list of GPM split modes is generated based on the first reordered GPM split modes and the second reordered GPM split modes, such as described above. In an example, the final reordered list of GPM split modes is [0, 1, 2, 3, 4, 7, 6, 5]. The GPM split mode from the list of GPM split modes is determined based on the final reordered list of GPM split modes. The plurality of GPM split modes is the list of GPM split modes.

In an aspect, the TM-based reordering and the sum of gradients based reordering are interleaving applied to the GPM split modes. The reordering process for the TM-based reordering and the sum of gradients based reordering is applied to even candidates (e.g., the GPM split modes have even numbers) and odd candidates (e.g., the GPM split modes have odd numbers), respectively. An example is shown as follows. The GPM split modes to be reordered include the GPM split modes 0 to 7. The TM-based reordering is applied to the even candidates including the GPM split modes 0, 2, 4, and 6, and the TM reordering list is [2, 0, 4, 6]. The sum of gradients based reordering is applied to the odd candidates including the GPM split modes 1, 3, 5, and 7, and the sum of gradients based reordering list is [1, 3, 7, 5]. When the TM-based reordering and the sum of gradients based reordering are interleaving applied to the GPM split modes 0-7, the final list is [2, 1, 0, 3, 4, 7, 6, 5].

In an example, the reordering process for the TM-based reordering and the sum of gradients based reordering is applied to odd candidates and even candidates, respectively.

In an example, the TM-based reordering and the sum of gradients based reordering are applied to the GPM split modes in an interleaved manner as follows: reordering the list of GPM split modes (e.g., [1, 3, 5, 7]) based on the respective sums of gradients to obtain a first reordered list of GPM split modes (e.g., [1, 3, 7, 5]). For each combination of (i) the pair of vectors in the one or more pairs of vectors and (ii) a GPM split mode in a second list of GPM split modes (e.g., [0, 2, 4, 6]) selected from the plurality of GPM split modes, where each GPM split mode in the second list is different from any GPM split mode in the list of GPM split modes (e.g., [1, 3, 5, 7]), a reference block of the current block is determined based on the respective pair of vectors and the respective GPM split mode in the second list. A TM cost between a reference template of the reference block and a current template of the current block is determined, and the second list of GPM split modes is reordered based on the TM costs to obtain a second reordered list of GPM split modes (e.g., [2, 0, 4, 6]). In some examples, a final reordered list of GPM split modes (e.g., [2, 1, 0, 3, 4, 7, 6, 5]) is generated by interleaving the first reordered list of GPM split modes (e.g., [1, 3, 7, 5]) and the second reordered list of GPM split modes (e.g., [2, 0, 4, 6]) (e.g., alternating elements from the two lists while preserving the relative order within each list), and the GPM split mode is determined based on the final reordered list of GPM split modes.

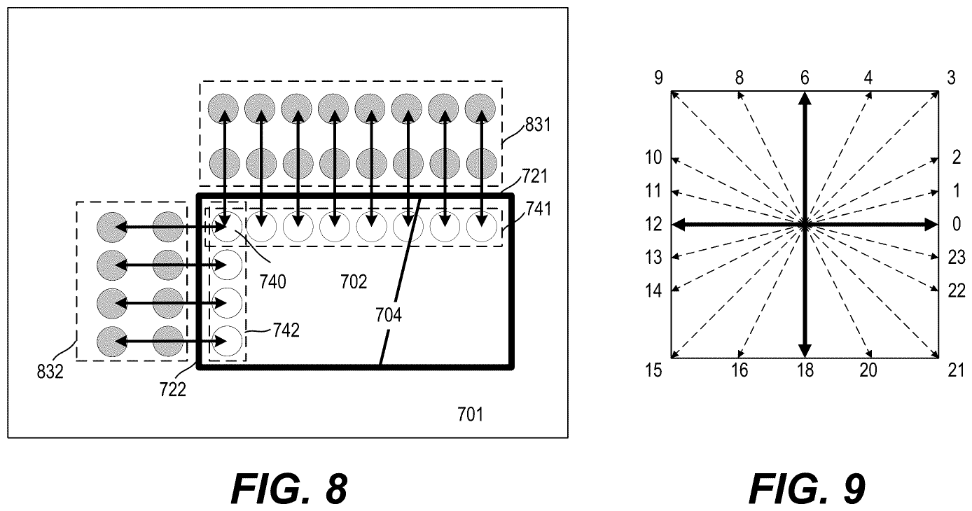

In an example, a different combination of the TM-based reordering and the sum of gradients based reordering is used. For example, one of the TM-based reordering and the sum of gradients based reordering is applied for a first list of GPM split modes having first GPM split edges corresponding to first plurality of angles. Referring to FIG. 9, in an example, the first plurality of angles includes angles 0, 6, 12, 18. The coarse angular set {0, 6, 12, 18} is an example, the first plurality of angles may include any suitable combination of angles.

In an aspect, search complexity may be reduced by selecting a GPM split mode corresponding to an angle from a coarse angular subset (e.g., {0, 6, 12, 18}) using a first criterion (e.g., one of (i) TM costs and (ii) sums of gradients) and then refining within a neighboring angular range according to a complementary criterion (e.g., another one of (i) TM costs and (ii) sums of gradients).

A first GPM split mode corresponding to the smallest sum of gradients or the smallest TM cost is determined. For example, the angle corresponding to the first GPM split mode is the angle 0. Then the other one of the TM-based reordering and the sum of gradients based reordering is applied to a second list of GPM split modes to determine an offset (e.g., an angular offset) to the angle corresponding to the first GPM split mode. In an example, the second list of GPM split modes include GPM split modes corresponding to the angles between the angles 18 and 6 that include the angle 0, for example, the second list of GPM split modes include the GPM split modes corresponding to the angles 20-23 and 0-4. In this method, the one of the TM-based reordering and the sum of gradients based reordering is applied to the coarse angular set (e.g., including the angles 0, 6, 12, 18), and the other one of the TM-based reordering and the sum of gradients based reordering is applied to refine the angle in an angular set that neighbors the selected angle (e.g., the angle 0). After applying the other one of the TM-based reordering and the sum of gradients based reordering, the offset is determined, for example, the offset is the angular difference between the angles 0 and 2, and thus the final angle is determined as the angle 2, the GPM split mode corresponding to the angle 2 is selected to partition the current block.

In an example, a first GPM split mode corresponding to the smallest sum of gradients among the sums of gradients computed for the list of GPM split modes is determined. Each GPM split mode in the list corresponds to a different angle. Referring to FIG. 9, the list of GPM split modes corresponds to the angles 0, 6, 12, 18. A first angle (e.g., the angle 0) that corresponds to the first GPM split mode is adjacent to two angles (e.g., the angles 6 and 18) that respectively correspond to two other GPM split modes in the list. For each combination of the pair of vectors in the one or more pairs of vectors and a GPM split mode in a second list of GPM split modes of the plurality of GPM split modes, a reference block of the current block is determined based on the respective pair of vectors and the respective GPM split mode in the second list of GPM split modes. The second list corresponds to second angles (e.g., the angles 20-23 and 0-4) between the two angles (e.g., the angles 6 and 18) adjacent to the first angle (e.g., the angle 0). A TM cost between a reference template of the reference block and a current template of the current block is determined. Based on the template-matching costs, the GPM split mode is determined from the second list of GPM split modes.

In an example, a reduced candidate subset may first be identified under one criterion (e.g., TM costs) and then refined under another (e.g., sums of gradients), with signaling facilitating either a deterministic selection or an index-based choice, such as described below.

In an aspect, a candidate list up to N (N>0) entries by using the sum of gradients based method is derived first. Then the TM-based based reordering is applied to the derived candidate list with a list size up to N. One of the N GPM split modes in the derived candidate list is used for the final prediction. In an example, a third flag is signaled, and the first entry with the least TM cost is used when the third flag is true. In an example, a fourth flag is signaled to indicate whether the method of deriving the candidate list up to N (N>0) entries using the sum of gradients based method and subsequently applying the TM-based method to the derived candidate list with the list size up to Nis used or not. If the fourth flag is true, an index syntax is further signaled to indicate the selected GPM split mode in the N-entry list. In an example, a syntax is decoded from the bitstream. When the syntax (e.g., a value of the syntax element) is larger than 0, the method of deriving the candidate list up to N entries using the sum of gradients based method and subsequently applying the TM-based method to the derived candidate list with the list size up to Nis used. Otherwise, this method is not used. If the syntax is larger than 0, the syntax value minus 1 indicates the index of the selected GPM split mode in the N-entry list. In this method, the order of applying the sum of gradients based method and the TM-based reordering may be switched.

In an example, a subset of GPM split modes (e.g., the candidate list up to N entries) in the list of GPM split modes is determined based on the sums of gradients. The plurality of GPM split modes is the list of GPM split modes. For each combination of (i) the pair of vectors in the one or more pairs of vectors and (ii) a GPM split mode in the subset of GPM split modes, a reference block of the current block is determined based on the respective pair of vectors and the respective GPM split mode. A TM cost between a reference template of the reference block and a current template of the current block is determined. The GPM split mode is determined from the subset of GPM split modes based on the TM costs. For example, the determined subset of GPM split modes (up to N entries) is reordered based on the TM costs, and the GPM split mode is determined from the reordered subset of GPM split modes.

In an aspect, signaling efficiency may be realized by jointly evaluating and selecting combinations of GPM split modes and predictive vector pairs using sums of gradients reordering. In an example, to improve the signaling of the combination of a GPM split mode and a pair of vectors for the two GPM partitions (e.g., (i) an MV pair including two MVs, (ii) a BV pair including two BVs, or (iii) a mixed pair including an MV and a BV) by using the calculation of the sums of gradients along the top and left coding block boundary, the following method may be used. For example, the signaling of the combination of the GPM split mode and the pair of vectors can be determined by calculating the sums of gradients for all combinations of the GPM split modes and the plurality of pairs of vectors. In an example, at the encoder side or the decoder side, the list of GPM split modes including L1 GPM split modes and the plurality of pairs of vectors including L2 pairs of vectors may be combined, for example, into L1×L2 combinations. The L1×L2 evaluation is an example. In some examples, pruning may be applied to reduce the number of combinations. A total of L1×L2 calculations of sums of gradients are performed. Each calculation of a sum of gradients may be performed using the descriptions above including the descriptions in FIGS. 7-8. The L1×L2 combinations of the GPM split modes and the plurality of pairs of vectors may be reordered based on the L1×L2 sums of gradients. A combination of a GPM split mode and a pair of vectors is selected based on the L1×L2 sums of gradients. In an example, an index is signaled in the bitstream to indicate the selected combination. In an example, the index is received at the decoder side, and is used to select the combination from the reordered L1×L2 combinations. Any of the methods described herein may also be applied, or adaptively applied, when jointly evaluating and selecting combinations of GPM split modes and predictive vector pairs using sums of gradients reordering.

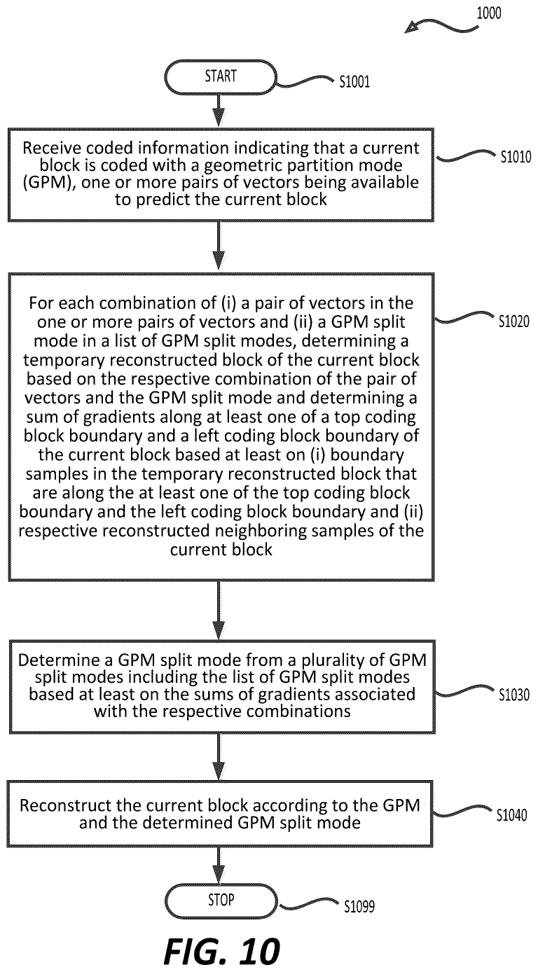

FIG. 10 shows a flow chart outlining a process (1000) according to an aspect of the disclosure. The process (1000) may be used in an apparatus, such as a video decoder. In various aspects, the process (1000) is executed by processing circuitry, such as the processing circuitry that performs functions of the video decoder (110), the processing circuitry that performs functions of the video decoder (210), and the like. In some aspects, the process (1000) is implemented in software instructions, thus when the processing circuitry executes the software instructions, the processing circuitry performs the process (1000). The process starts at (S1001) and proceeds to (S1010).

At (S1010), coded information indicating that a current block is coded with a geometric partition mode (GPM) is received, and one or more pairs of vectors are available to predict the current block.

In an example, the one or more pairs of vectors is a pair of vectors.

In an example, each pair of vectors in the one or more pairs of vectors includes (i) two motion vectors (MVs) for inter prediction, (ii) two block vectors (BVs) for an intra block copy (IBC) mode and/or an intra template-matching prediction (IntraTMP) mode, or (iii) an MV for the inter prediction and a BV for the IBC mode or the IntraTMP mode.

At (S1020), for each combination of (i) a pair of vectors in the one or more pairs of vectors and (ii) a GPM split mode in a list of GPM split modes, a temporary reconstructed block of the current block is determined based on the respective combination of the pair of vectors and the GPM split mode, and a sum of gradients along at least one of a top coding block boundary and a left coding block boundary of the current block is determined based at least on (i) boundary samples in the temporary reconstructed block that are along the at least one of the top coding block boundary and the left coding block boundary and (ii) respective reconstructed neighboring samples of the current block.

In an example, for each combination of (i) the pair of vectors in the one or more pairs of vectors and (ii) the GPM split mode in the list of GPM split modes, the temporary reconstructed block is determined as follows. A first prediction of the current block is determined based on a first vector of the respective pair of vectors. A second prediction of the current block is determined based on a second vector of the respective pair of vectors. The temporary reconstructed block of the current block is then determined by blending the first prediction and the second prediction based on the respective GPM split mode and a blending width.

In an example, for each combination of (i) the pair of vectors in the one or more pairs of vectors and (ii) the GPM split mode in the list of GPM split modes, a first prediction of the current block is determined based on a first vector of the respective pair of vectors, a second prediction of the current block is determined based on a second vector of the respective pair of vectors, an intermediate block of the current block is determined by blending the first prediction and the second prediction based on the respective GPM split mode and a blending width. The temporary reconstructed block of the current block is determined based on the intermediate block and a residual block.

In an example, the at least one of the top coding block boundary and the left coding block boundary of the current block includes the top coding block boundary and the left coding block boundary of the current block.

At (S1030), a GPM split mode is determined from a plurality of GPM split modes that includes the list of GPM split modes based at least on the sums of gradients associated with the respective combinations.

At (S1040), the current block is reconstructed according to the GPM and the determined GPM split mode.

Then, the process proceeds to (S1099) and terminates.

The process (1000) may be suitably adapted. Step(s) in the process (1000) may be modified and/or omitted. Additional step(s) may be added. Any suitable order of implementation may be used.

In an example, the one or more pairs of vectors include a plurality of pairs of vectors.

In an example, the list of GPM split modes is reordered based on the sums of gradients and the GPM split mode is determined based on a syntax element in the coded information. The syntax element indicates the GPM split mode in the reordered list of GPM split modes, and the plurality of GPM split modes is the list of GPM split modes.

In an example, the coded information includes a flag indicating that the list of GPM split modes is reordered based on the sums of gradients.

In an example, the coded information includes a flag indicating a GPM split mode in the list of GPM split modes corresponding to the smallest sum of gradients in the sums of gradients is to be the GPM split mode. The plurality of GPM split modes is the list of GPM split modes. That the GPM split mode corresponding to the smallest sum of gradients in the sums of gradients is the GPM split mode is determined.

In an example, the list of GPM split modes is reordered based on the sums of gradients as a first reordered list of GPM split modes. For each combination of (i) the pair of vectors in the one or more pairs of vectors and (ii) the GPM split mode in the list of GPM split modes, a reference block of the current block is determined based on the respective pair of vectors and the respective GPM split mode and a template-matching (TM) cost between a reference template of the reference block and a current template of the current block is determined. The list of GPM split modes is reordered based on the TM costs as a second reordered list of GPM split modes. A final reordered list of GPM split modes is generated based on the first reordered GPM split modes and the second reordered GPM split modes. The GPM split mode from the list of GPM split modes is determined based on the final reordered list of GPM split modes, and the plurality of GPM split modes is the list of GPM split modes.

In an example, the list of GPM split modes is reordered based on the sums of gradients as a first reordered GPM split modes. For each combination of (i) the pair of vectors in the one or more pairs of vectors and (ii) a GPM split mode in a second list of GPM split modes in the plurality of GPM split modes, a reference block of the current block is determined based on the respective pair of vectors and the respective GPM split mode in the second list of GPM split modes. A template-matching (TM) cost between a reference template of the reference block and a current template of the current block is determined. Each GPM split mode in the second list of GPM split modes is different from any GPM split mode in the list of GPM split modes. The second list of GPM split modes is reordered based on the TM costs as a second reordered GPM split modes. A final reordered list of GPM split modes is generated by interleaving the first reordered GPM split modes and the second reordered GPM split modes. The GPM split mode is determined based on the final reordered list of GPM split modes.

In an example, a first GPM split mode corresponding to the smallest sum of gradients in the sums of gradients is determined. Each GPM split mode in the list of GPM split modes corresponds to a different angle. A first angle that corresponds to the first GPM split mode is adjacent to two angles corresponding to two respective GPM split modes in the list of GPM split modes. For each combination of (i) the pair of vectors in the one or more pairs of vectors and (ii) a GPM split mode in a second list of GPM split modes of the plurality of GPM split modes corresponding to second angles between the two angles, a reference block of the current block is determined based on the respective pair of vectors and the respective GPM split mode in the second list of GPM split modes and a template-matching (TM) cost between a reference template of the reference block and a current template of the current block is determined. The GPM split mode is determined from the second list of GPM split modes based on the TM costs.

In an example, a subset of GPM split modes in the list of GPM split modes is determined based on the sums of gradients. The plurality of GPM split modes is the list of GPM split modes. For each combination of (i) the pair of vectors in the one or more pairs of vectors and (ii) a GPM split mode in the subset of GPM split modes, a reference block of the current block is determined based on the respective pair of vectors and the respective GPM split mode and a template-matching (TM) cost between a reference template of the reference block and a current template of the current block is determined. The GPM split mode is determined from the subset of GPM split modes based on the TM costs.

In an aspect, a method of processing visual media data includes processing a bitstream of the visual media data according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an aspect, the bitstream includes coded information indicating that a current block is coded with a geometric partition mode (GPM) with multiple blending width sets is received. The format rules specifies that a blending width set is determined from the multiple blending width sets to be applied to the current block based on block size information and GPM information of the current block; a blending width is determined from the determined blending width set; and the current block is reconstructed according to the GPM and the determined blending width.

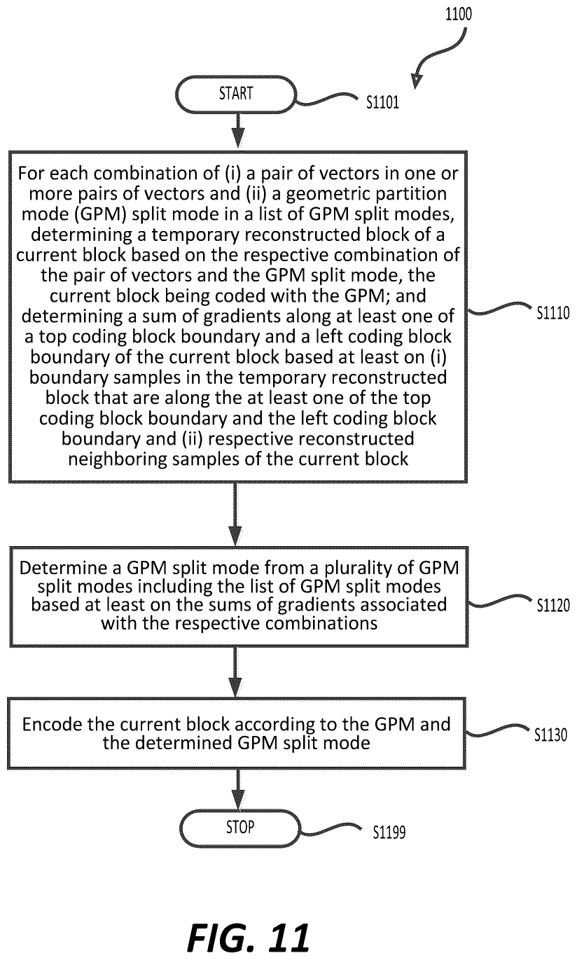

FIG. 11 shows a flow chart outlining a process (1100) according to an aspect of the disclosure. The process (1100) can be used in an apparatus. The apparatus may include a mesh encoder, such as a video encoder. The video encoder is configured to, for example, to encode one or more meshes. In various aspects, the process (1100) is executed by processing circuitry, such as the processing circuitry that performs functions of the video encoder (103), the processing circuitry that performs functions of the video encoder (303), the mesh encoder, and/or the like. In some aspects, the process (1100) is implemented in software instructions, thus when the processing circuitry executes the software instructions, the processing circuitry performs the process (1100). The process starts at (S1101) and proceeds to (S1110).

At (S1110), for each combination of (i) a pair of vectors in one or more pairs of vectors and (ii) a geometric partition mode (GPM) split mode in a list of GPM split modes, a temporary reconstructed block of a current block is determined based on the respective combination of the pair of vectors and the GPM split mode. The current block is coded with the GPM. A sum of gradients along at least one of a top coding block boundary and a left coding block boundary of the current block is determined based at least on (i) boundary samples in the temporary reconstructed block that are along the at least one of the top coding block boundary and the left coding block boundary and (ii) respective reconstructed neighboring samples of the current block.

In an example, the one or more pairs of vectors is a pair of vectors.

In an example, the one or more pairs of vectors include a plurality of pairs of vectors.

In an example, each pair of vectors in the one or more pairs of vectors includes (i) two motion vectors (MVs) for inter prediction, (ii) two block vectors (BVs) for an intra block copy (IBC) mode and/or an intra template-matching prediction (IntraTMP) mode, or (iii) an MV for the inter prediction and a BV for the IBC mode or the IntraTMP mode.

In an example, for each combination of (i) the pair of vectors in the one or more pairs of vectors and (ii) the GPM split mode in the list of GPM split modes, the determining of the temporary reconstructed block is performed by (a) determining a first prediction of the current block based on a first vector of the respective pair of vectors, (b) determining a second prediction of the current block based on a second vector of the respective pair of vectors, and (c) determining the temporary reconstructed block of the current block by blending the first prediction and the second prediction based on the respective GPM split mode and a blending width.

At (S1120), a GPM split mode from a plurality of GPM split modes including the list of GPM split modes is determined based at least on the sums of gradients associated with the respective combinations.

At (S1130), the current block is encoded according to the GPM and the determined GPM split mode.

Then, the process proceeds to (S1199) and terminates.

The process (1100) may be suitably adapted. Step(s) in the process (1100) may be modified and/or omitted. Additional step(s) may be added. Any suitable order of implementation may be used.

In an aspect, a non-transitory computer-readable storage medium storing instructions which when executed by a processor cause the processor to perform an encoding method including: for each combination of (i) a pair of vectors in one or more pairs of vectors and (ii) a geometric partition mode (GPM) split mode in a list of GPM split modes, determining a temporary reconstructed block of a current block based on the respective combination of the pair of vectors and the GPM split mode, the current block being coded with the GPM, and determining a sum of gradients along at least one of a top coding block boundary and a left coding block boundary of the current block based at least on (i) boundary samples in the temporary reconstructed block that are along the at least one of the top coding block boundary and the left coding block boundary and (ii) respective reconstructed neighboring samples of the current block; determining a GPM split mode from a plurality of GPM split modes including the list of GPM split modes based at least on the sums of gradients associated with the respective combinations; encoding the current block according to the GPM and the determined GPM split mode; and transmitting a bitstream including the encoded current block and coded information indicating that the current block is coded with the GPM.

In some examples, the sum of gradients reordering technique provides multiple implementation and system-level advantages relative to the TM-based reordering method. In an example, the sum of gradients approach operates, for example, only on the samples of the current block together with its neighboring reconstructed samples to compute the gradient sum and determine the reordering outcome. In some examples, the TM-based reordering additionally uses a stored reference template. In an example, avoiding the template fetch eliminates the need to access and maintain a template structure, thereby reducing memory bandwidth requirements. In some examples, by confining computation to a local block and neighbor data, the sum of gradients method reduces random memory accesses and diminishes memory stalls, which in turn lowers end-to-end latency for reordering decisions. The streamlined memory footprint may enable smaller buffers and reduces memory traffic, contributing to lower power consumption and more favorable area/power-performance trade-offs in hardware implementations.

From an architectural perspective, in some examples, the sum-of-gradients method simplifies the reordering pipeline. In some examples, the localized data dependencies of the sum of gradients method may also facilitate parallelization across blocks, with reduced inter-unit communication and fewer hazards associated with shared template state. These properties may enhance scalability to higher resolutions and higher throughput operating points without proportionally increasing bandwidth pressure.

In some examples, the sum of gradients method approach is capable of achieving performance comparable to TM reordering while operating with reduced bandwidth and lower implementation complexity. In an example, this balance yields practical benefits across both software and hardware deployments, including decreased memory subsystem contention, improved determinism in runtime behavior, and more robust performance on platforms with constrained memory bandwidth.

The various terms in the disclosure may refer to the respective terms or corresponding variants. For example, the term “IBC mode” refers to the IBC mode or a variant, the term “IntraTMP mode” refers to the IntraTMP mode or a variant, the term “GPM” refers to the GPM or a variant, the term “sum of gradients” refers to the sum of gradients or a variant, the term template matching refers to the template matching or a variant, and the like.

Methods, aspects and/or examples in the disclosure may be used separately or combined in any order. For example, some aspects and/or examples performed by the decoder may be performed by the encoder and vice versa. Each of the methods (or aspects), an encoder, and a decoder may be implemented by processing circuitry (e.g., one or more processors or one or more integrated circuits). In one example, the one or more processors execute a program that is stored in a non-transitory computer-readable medium.

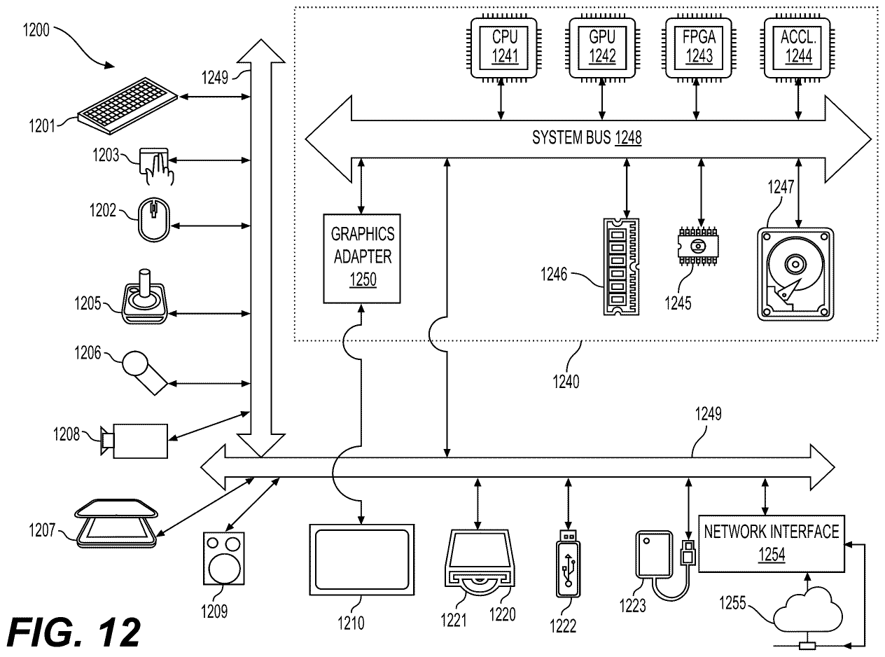

The techniques described above, may be implemented as computer software using computer-readable instructions and physically stored in one or more computer-readable media. For example, FIG. 12 shows a computer system (1200) suitable for implementing certain aspects of the disclosed subject matter.

The computer software may be coded using any suitable machine code or computer language, that may be subject to assembly, compilation, linking, or like mechanisms to create code comprising instructions that may be executed directly, or through interpretation, micro-code execution, and the like, by one or more computer central processing units (CPUs), Graphics Processing Units (GPUs), and the like.

The instructions may be executed on various types of computers or components thereof, including, for example, personal computers, tablet computers, servers, smartphones, gaming devices, internet of things devices, and the like.

The components shown in FIG. 12 for computer system (1200) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of a computer system (1200).

Computer system (1200) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices may also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1201), mouse (1202), trackpad (1203), touch screen (1210), data-glove (not shown), joystick (1205), microphone (1206), scanner (1207), camera (1208).

Computer system (1200) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1210), data-glove (not shown), or joystick (1205), but there may also be tactile feedback devices that do not serve as input devices), audio output devices (such as: speakers (1209), headphones (not depicted)), visual output devices (such as screens (1210) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1200) may also include human accessible storage devices and their associated media such as optical media including CD/DVD ROM/RW (1220) with CD/DVD or the like media (1221), thumb-drive (1222), removable hard drive or solid state drive (1223), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1200) may also include an interface (1254) to one or more communication networks (1255). Networks may for example be wireless, wireline, optical. Networks may further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1249) (such as, for example USB ports of the computer system (1200)); others are commonly integrated into the core of the computer system (1200) by attachment to a system bus as described below (for example Ethernet interface into a PC computer system or cellular network interface into a smartphone computer system). Using any of these networks, computer system (1200) may communicate with other entities. Such communication may be uni-directional, receive only (for example, broadcast TV), uni-directional send-only (for example CANbus to certain CANbus devices), or bi-directional, for example to other computer systems using local or wide area digital networks. Certain protocols and protocol stacks may be used on each of those networks and network interfaces as described above.

Aforementioned human interface devices, human-accessible storage devices, and network interfaces may be attached to a core (1240) of the computer system (1200).

The core (1240) may include one or more Central Processing Units (CPU) (1241), Graphics Processing Units (GPU) (1242), specialized programmable processing units in the form of Field Programmable Gate Areas (FPGA) (1243), hardware accelerators for certain tasks (1244), graphics adapters (1250), and so forth. These devices, along with Read-only memory (ROM) (1245), Random-access memory (1246), internal mass storage such as internal non-user accessible hard drives, SSDs, and the like (1247), may be connected through a system bus (1248). In some computer systems, the system bus (1248) may be accessible in the form of one or more physical plugs to enable extensions by additional CPUs, GPU, and the like. The peripheral devices may be attached either directly to the core's system bus (1248), or through a peripheral bus (1249). In an example, the screen (1210) may be connected to the graphics adapter (1250). Architectures for a peripheral bus include PCI, USB, and the like.

CPUs (1241), GPUs (1242), FPGAs (1243), and accelerators (1244) may execute certain instructions that, in combination, may make up the aforementioned computer code. That computer code may be stored in ROM (1245) or RAM (1246). Transitional data may also be stored in RAM (1246), whereas permanent data may be stored for example, in the internal mass storage (1247). Fast storage and retrieve to any of the memory devices may be enabled through the use of cache memory, that may be closely associated with one or more CPU (1241), GPU (1242), mass storage (1247), ROM (1245), RAM (1246), and the like.

The computer readable media may have computer code thereon for performing various computer-implemented operations. The media and computer code may be those specially designed and constructed for the purposes of the present disclosure, or they may be of the kind well known and available to those having skill in the computer software arts.

As an example and not by way of limitation, the computer system having architecture (1200), and specifically the core (1240) may provide functionality as a result of processor(s) (including CPUs, GPUs, FPGA, accelerators, and the like) executing software embodied in one or more tangible, computer-readable media. Such computer-readable media may be media associated with user-accessible mass storage as introduced above, as well as certain storage of the core (1240) that are of non-transitory nature, such as core-internal mass storage (1247) or ROM (1245). The software implementing various aspects of the present disclosure may be stored in such devices and executed by core (1240). A computer-readable medium may include one or more memory devices or chips, according to particular needs. The software may cause the core (1240) and specifically the processors therein (including CPU, GPU, FPGA, and the like) to execute particular processes or particular parts of particular processes described herein, including defining data structures stored in RAM (1246) and modifying such data structures according to the processes defined by the software. In addition or as an alternative, the computer system may provide functionality as a result of logic hardwired or otherwise embodied in a circuit (for example: accelerator (1244)), which may operate in place of or together with software to execute particular processes or particular parts of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

The use of “at least one of” or “one of’ in the disclosure is intended to include any one or a combination of the recited elements. For example, references to at least one of A, B, or C; at least one of A, B, and C; at least one of A, B, and/or C; and at least one of A to Care intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.
(1) A method for video decoding, the method including: receiving coded information indicating that a current block is coded with a geometric partition mode (GPM), one or more pairs of vectors being available to predict the current block; for each combination of (i) a pair of vectors in the one or more pairs of vectors and (ii) a GPM split mode in a list of GPM split modes, determining a temporary reconstructed block of the current block based on the respective combination of the pair of vectors and the GPM split mode; and determining a sum of gradients along at least one of a top coding block boundary and a left coding block boundary of the current block based at least on (i) boundary samples in the temporary reconstructed block that are along the at least one of the top coding block boundary and the left coding block boundary and (ii) respective reconstructed neighboring samples of the current block; determining a GPM split mode from a plurality of GPM split modes including the list of GPM split modes based at least on the sums of gradients associated with the respective combinations; and reconstructing the current block according to the GPM and the determined GPM split mode.
(2) The method of feature (1), in which the one or more pairs of vectors is a pair of vectors.
(3) The method of feature (1) or (2), in which each pair of vectors in the one or more pairs of vectors includes (i) two motion vectors (MVs) for inter prediction, (ii) two block vectors (BVs) for an intra block copy (IBC) mode and/or an intra template-matching prediction (IntraTMP) mode, or (iii) an MV for the inter prediction and a BV for the IBC mode or the IntraTMP mode.
(4) The method of any of features (1) to (3), in which for each combination of (i) the pair of vectors in the one or more pairs of vectors and (ii) the GPM split mode in the list of GPM split modes, the determining the temporary reconstructed block includes: determining a first prediction of the current block based on a first vector of the respective pair of vectors; determining a second prediction of the current block based on a second vector of the respective pair of vectors; and determining the temporary reconstructed block of the current block by blending the first prediction and the second prediction based on the respective GPM split mode and a blending width.
(5) The method of any of features (1) to (3), in which for each combination of (i) the pair of vectors in the one or more pairs of vectors and (ii) the GPM split mode in the list of GPM split modes, the determining the temporary reconstructed block includes: determining a first prediction of the current block based on a first vector of the respective pair of vectors; determining a second prediction of the current block based on a second vector of the respective pair of vectors; determining an intermediate block of the current block by blending the first prediction and the second prediction based on the respective GPM split mode and a blending width; and determining the temporary reconstructed block of the current block based on the intermediate block and a residual block.
(6) The method of any of features (1) to (3), in which the determining the GPM split mode includes: reordering the list of GPM split modes based on the sums of gradients; and determining the GPM split mode based on a syntax element in the coded information, the syntax element indicating the GPM split mode in the reordered list of GPM split modes, the plurality of GPM split modes being the list of GPM split modes.
(7) The method of feature (6), in which the coded information includes a flag indicating that the list of GPM split modes is reordered based on the sums of gradients.
(8) The method of any of features (1) to (3), in which the coded information includes a flag indicating a GPM split mode in the list of GPM split modes corresponding to the smallest sum of gradients in the sums of gradients is to be the GPM split mode, the plurality of GPM split modes being the list of GPM split modes; and the determining the GPM split mode includes determining that the GPM split mode corresponding to the smallest sum of gradients in the sums of gradients is the GPM split mode.
(9) The method of any of features (1) to (3), in which reordering the list of GPM split modes based on the sums of gradients as a first reordered list of GPM split modes; for each combination of (i) the pair of vectors in the one or more pairs of vectors and (ii) the GPM split mode in the list of GPM split modes, determining a reference block of the current block based on the respective pair of vectors and the respective GPM split mode; and determining a template-matching (TM) cost between a reference template of the reference block and a current template of the current block; reordering the list of GPM split modes based on the TM costs as a second reordered list of GPM split modes; and the determining the GPM split mode includes generating a final reordered list of GPM split modes based on the first reordered GPM split modes and the second reordered GPM split modes; and determining the GPM split mode from the list of GPM split modes based on the final reordered list of GPM split modes, the plurality of GPM split modes being the list of GPM split modes.
(10) The method of any of features (1) to (3), in which the method further includes: reordering the list of GPM split modes based on the sums of gradients as a first reordered GPM split modes; for each combination of (i) the pair of vectors in the one or more pairs of vectors and (ii) a GPM split mode in a second list of GPM split modes in the plurality of GPM split modes, each GPM split mode in the second list of GPM split modes being different from any GPM split mode in the list of GPM split modes; determining a reference block of the current block based on the respective pair of vectors and the respective GPM split mode in the second list of GPM split modes; and determining a template-matching (TM) cost between a reference template of the reference block and a current template of the current block; and reordering the second list of GPM split modes based on the TM costs as a second list of reordered GPM split modes; and the determining the GPM split mode includes generating a final reordered list of GPM split modes by interleaving the first reordered GPM split modes and the second reordered GPM split modes; and determining the GPM split mode based on the final reordered list of GPM split modes.
(11) The method of any of features (1) to (3), in which the determining the GPM split mode includes: determining a first GPM split mode corresponding to the smallest sum of gradients in the sums of gradients, each GPM split mode in the list of GPM split modes corresponding to a different angle, a first angle that corresponds to the first GPM split mode being adjacent to two angles corresponding to two respective GPM split modes in the list of GPM split modes, for each combination of (i) the pair of vectors in the one or more pairs of vectors and (ii) a GPM split mode in a second list of GPM split modes of the plurality of GPM split modes corresponding to second angles between the two angles; determining a reference block of the current block based on the respective pair of vectors and the respective GPM split mode in the second list of GPM split modes; and determining a template-matching (TM) cost between a reference template of the reference block and a current template of the current block; and determining the GPM split mode from the second list of GPM split modes based on the TM costs.
(12) The method of any of features (1) to (3), in which the determining the GPM split mode includes: determining a subset of GPM split modes in the list of GPM split modes based on the sums of gradients, the plurality of GPM split modes being the list of GPM split modes; for each combination of (i) the pair of vectors in the one or more pairs of vectors and (ii) a GPM split mode in the subset of GPM split modes, determining a reference block of the current block based on the respective pair of vectors and the respective GPM split mode; and determining a template-matching (TM) cost between a reference template of the reference block and a current template of the current block; and determining the GPM split mode from the subset of GPM split modes based on the TM costs.
(13) The method of feature (1), in which the one or more pairs of vectors include a plurality of pairs of vectors.
(14) The method of any of features (1) to (3), in which the at least one of the top coding block boundary and the left coding block boundary of the current block includes the top coding block boundary and the left coding block boundary of the current block.
(15) A method for video encoding, the method including: for each combination of (i) a pair of vectors in one or more pairs of vectors and (ii) a geometric partition mode (GPM) split mode in a list of GPM split modes, determining a temporary reconstructed block of a current block based on the respective combination of the pair of vectors and the GPM split mode, the current block being coded with the GPM; and determining a sum of gradients along at least one of a top coding block boundary and a left coding block boundary of the current block based at least on (i) boundary samples in the temporary reconstructed block that are along the at least one of the top coding block boundary and the left coding block boundary and (ii) respective reconstructed neighboring samples of the current block; determining a GPM split mode from a plurality of GPM split modes including the list of GPM split modes based at least on the sums of gradients associated with the respective combinations; and encoding the current block according to the GPM and the determined GPM split mode.
(16) The method of feature (15), in which the one or more pairs of vectors is a pair of vectors.
(17) The method of feature (15) or (16), in which each pair of vectors in the one or more pairs of vectors includes (i) two motion vectors (MVs) for inter prediction, (ii) two block vectors (BVs) for an intra block copy (IBC) mode and/or an intra template-matching prediction (IntraTMP) mode, or (iii) an MV for the inter prediction and a BV for the IBC mode or the IntraTMP mode.
(18) The method of any of features (15) to (17), in which for each combination of (i) the pair of vectors in the one or more pairs of vectors and (ii) the GPM split mode in the list of GPM split modes, the determining the temporary reconstructed block includes: determining a first prediction of the current block based on a first vector of the respective pair of vectors; determining a second prediction of the current block based on a second vector of the respective pair of vectors; and determining the temporary reconstructed block of the current block by blending the first prediction and the second prediction based on the respective GPM split mode and a blending width.
(19) The method of feature (15), in which the one or more pairs of vectors include a plurality of pairs of vectors.
(20) A non-transitory computer-readable storage medium storing instructions which when executed by a processor cause the processor to perform an encoding method including: for each combination of (i) a pair of vectors in one or more pairs of vectors and (ii) a geometric partition mode (GPM) split mode in a list of GPM split modes, determining a temporary reconstructed block of a current block based on the respective combination of the pair of vectors and the GPM split mode, the current block being coded with the GPM; and determining a sum of gradients along at least one of a top coding block boundary and a left coding block boundary of the current block based at least on (i) boundary samples in the temporary reconstructed block that are along the at least one of the top coding block boundary and the left coding block boundary and (ii) respective reconstructed neighboring samples of the current block; determining a GPM split mode from a plurality of GPM split modes including the list of GPM split modes based at least on the sums of gradients associated with the respective combinations; encoding the current block according to the GPM and the determined GPM split mode; and transmitting a bitstream including the encoded current block and coded information indicating that the current block is coded with the GPM.
(21) An apparatus of video decoding, including processing circuitry that is configured to perform the method of any of features (1) to (14).
(22) An apparatus of video encoding, including processing circuitry that is configured to perform the method of any of features (15) to (19).
(23) A non-transitory computer-readable storage medium storing instructions which when executed by at least one processor cause the at least one processor to perform the method of any of features (1) to (19).

What is claimed is:

1. A method for video decoding, the method comprising:
receiving coded information indicating that a current block is coded with a geometric partition mode (GPM), one or more pairs of vectors being available to predict the current block;
for each combination of (i) a pair of vectors in the one or more pairs of vectors and (ii) a GPM split mode in a list of GPM split modes,
determining a temporary reconstructed block of the current block based on the respective combination of the pair of vectors and the GPM split mode; and
determining a sum of gradients along at least one of a top coding block boundary and a left coding block boundary of the current block based at least on (i) boundary samples in the temporary reconstructed block that are along the at least one of the top coding block boundary and the left coding block boundary and (ii) respective reconstructed neighboring samples of the current block;
determining a GPM split mode from a plurality of GPM split modes including the list of GPM split modes based at least on the sums of gradients associated with the respective combinations; and
reconstructing the current block according to the GPM and the determined GPM split mode.

2. The method of claim 1, wherein the one or more pairs of vectors is a pair of vectors.

3. The method of claim 1, wherein each pair of vectors in the one or more pairs of vectors comprises (i) two motion vectors (MVs) for inter prediction, (ii) two block vectors (BVs) for an intra block copy (IBC) mode and/or an intra template-matching prediction (IntraTMP) mode, or (iii) an MV for the inter prediction and a BV for the IBC mode or the IntraTMP mode.

4. The method of claim 1, wherein
for each combination of (i) the pair of vectors in the one or more pairs of vectors and (ii) the GPM split mode in the list of GPM split modes, the determining the temporary reconstructed block comprises:
determining a first prediction of the current block based on a first vector of the respective pair of vectors;
determining a second prediction of the current block based on a second vector of the respective pair of vectors; and
determining the temporary reconstructed block of the current block by blending the first prediction and the second prediction based on the respective GPM split mode and a blending width.

5. The method of claim 1, wherein for each combination of (i) the pair of vectors in the one or more pairs of vectors and (ii) the GPM split mode in the list of GPM split modes, the determining the temporary reconstructed block includes:
determining a first prediction of the current block based on a first vector of the respective pair of vectors;
determining a second prediction of the current block based on a second vector of the respective pair of vectors;
determining an intermediate block of the current block by blending the first prediction and the second prediction based on the respective GPM split mode and a blending width; and
determining the temporary reconstructed block of the current block based on the intermediate block and a residual block.

6. The method of claim 1, wherein the determining the GPM split mode comprises:
reordering the list of GPM split modes based on the sums of gradients; and
determining the GPM split mode based on a syntax element in the coded information, the syntax element indicating the GPM split mode in the reordered list of GPM split modes, the plurality of GPM split modes being the list of GPM split modes.

7. The method of claim 6, wherein the coded information includes a flag indicating that the list of GPM split modes is reordered based on the sums of gradients.

8. The method of claim 1, wherein
the coded information includes a flag indicating a GPM split mode in the list of GPM split modes corresponding to the smallest sum of gradients in the sums of gradients is to be the GPM split mode, the plurality of GPM split modes being the list of GPM split modes; and
the determining the GPM split mode includes determining that the GPM split mode corresponding to the smallest sum of gradients in the sums of gradients is the GPM split mode.

9. The method of claim 1, further comprising:
reordering the list of GPM split modes based on the sums of gradients as a first reordered list of GPM split modes;
for each combination of (i) the pair of vectors in the one or more pairs of vectors and (ii) the GPM split mode in the list of GPM split modes,
determining a reference block of the current block based on the respective pair of vectors and the respective GPM split mode; and
determining a template-matching (TM) cost between a reference template of the reference block and a current template of the current block;
reordering the list of GPM split modes based on the TM costs as a second reordered list of GPM split modes; and
the determining the GPM split mode includes
generating a final reordered list of GPM split modes based on the first reordered GPM split modes and the second reordered GPM split modes; and
determining the GPM split mode from the list of GPM split modes based on the final reordered list of GPM split modes, the plurality of GPM split modes being the list of GPM split modes.

10. The method of claim 1, wherein
the method further includes:
reordering the list of GPM split modes based on the sums of gradients as a first reordered GPM split modes;
for each combination of (i) the pair of vectors in the one or more pairs of vectors and (ii) a GPM split mode in a second list of GPM split modes in the plurality of GPM split modes, each GPM split mode in the second list of GPM split modes being different from any GPM split mode in the list of GPM split modes;
determining a reference block of the current block based on the respective pair of vectors and the respective GPM split mode in the second list of GPM split modes; and
determining a template-matching (TM) cost between a reference template of the reference block and a current template of the current block; and
reordering the second list of GPM split modes based on the TM costs as a second list of reordered GPM split modes; and
the determining the GPM split mode includes
generating a final reordered list of GPM split modes by interleaving the first reordered GPM split modes and the second reordered GPM split modes; and
determining the GPM split mode based on the final reordered list of GPM split modes.

11. The method of claim 1, wherein the determining the GPM split mode comprises:
determining a first GPM split mode corresponding to the smallest sum of gradients in the sums of gradients, each GPM split mode in the list of GPM split modes corresponding to a different angle, a first angle that corresponds to the first GPM split mode being adjacent to two angles corresponding to two respective GPM split modes in the list of GPM split modes,
for each combination of (i) the pair of vectors in the one or more pairs of vectors and (ii) a GPM split mode in a second list of GPM split modes of the plurality of GPM split modes corresponding to second angles between the two angles;
determining a reference block of the current block based on the respective pair of vectors and the respective GPM split mode in the second list of GPM split modes; and
determining a template-matching (TM) cost between a reference template of the reference block and a current template of the current block; and
determining the GPM split mode from the second list of GPM split modes based on the TM costs.

12. The method of claim 1, wherein the determining the GPM split mode comprises:
determining a subset of GPM split modes in the list of GPM split modes based on the sums of gradients, the plurality of GPM split modes being the list of GPM split modes;
for each combination of (i) the pair of vectors in the one or more pairs of vectors and (ii) a GPM split mode in the subset of GPM split modes,
determining a reference block of the current block based on the respective pair of vectors and the respective GPM split mode; and
determining a template-matching (TM) cost between a reference template of the reference block and a current template of the current block; and
determining the GPM split mode from the subset of GPM split modes based on the TM costs.

13. The method of claim 1, wherein the one or more pairs of vectors include a plurality of pairs of vectors.

14. The method of claim 1, wherein the at least one of the top coding block boundary and the left coding block boundary of the current block comprises the top coding block boundary and the left coding block boundary of the current block.

15. A method for video encoding, the method comprising:
for each combination of (i) a pair of vectors in one or more pairs of vectors and (ii) a geometric partition mode (GPM) split mode in a list of GPM split modes,
determining a temporary reconstructed block of a current block based on the respective combination of the pair of vectors and the GPM split mode, the current block being coded with the GPM; and
determining a sum of gradients along at least one of a top coding block boundary and a left coding block boundary of the current block based at least on (i) boundary samples in the temporary reconstructed block that are along the at least one of the top coding block boundary and the left coding block boundary and (ii) respective reconstructed neighboring samples of the current block;
determining a GPM split mode from a plurality of GPM split modes including the list of GPM split modes based at least on the sums of gradients associated with the respective combinations; and
encoding the current block according to the GPM and the determined GPM split mode.

16. The method of claim 15, wherein the one or more pairs of vectors is a pair of vectors.

17. The method of claim 15, wherein each pair of vectors in the one or more pairs of vectors comprises (i) two motion vectors (MVs) for inter prediction, (ii) two block vectors (BVs) for an intra block copy (IBC) mode and/or an intra template-matching prediction (IntraTMP) mode, or (iii) an MV for the inter prediction and a BV for the IBC mode or the IntraTMP mode.

18. The method of claim 15, wherein
for each combination of (i) the pair of vectors in the one or more pairs of vectors and (ii) the GPM split mode in the list of GPM split modes, the determining the temporary reconstructed block comprises:
determining a first prediction of the current block based on a first vector of the respective pair of vectors;
determining a second prediction of the current block based on a second vector of the respective pair of vectors; and
determining the temporary reconstructed block of the current block by blending the first prediction and the second prediction based on the respective GPM split mode and a blending width.

19. The method of claim 15, wherein the one or more pairs of vectors include a plurality of pairs of vectors.

20. A non-transitory computer-readable storage medium storing instructions which when executed by a processor cause the processor to perform a method of encoding a bitstream comprising:
for each combination of (i) a pair of vectors in one or more pairs of vectors and (ii) a geometric partition mode (GPM) split mode in a list of GPM split modes,
determining a temporary reconstructed block of a current block based on the respective combination of the pair of vectors and the GPM split mode, the current block being coded with the GPM; and
determining a sum of gradients along at least one of a top coding block boundary and a left coding block boundary of the current block based at least on (i) boundary samples in the temporary reconstructed block that are along the at least one of the top coding block boundary and the left coding block boundary and (ii) respective reconstructed neighboring samples of the current block;
determining a GPM split mode from a plurality of GPM split modes including the list of GPM split modes based at least on the sums of gradients associated with the respective combinations;
encoding the current block according to the GPM and the determined GPM split mode; and
transmitting the bitstream including the encoded current block and coded information indicating that the current block is coded with the GPM.
